(19) United States
(12) Patent Application Publication
(10) Pub. No.: US 2017/0227122 A1
(43) Pub. Date: Aug. 10, 2017

(54) Method for Adaptive Ratio Control in a Ball Planetary Continously Variable Transmission

(71) Applicant: Dana Limited, Maumee, OH (US)

(72) Inventors: Jeffrey M. David, Cedar Park, TX (US); Thomas Neil McLemore, Georgetown, TX (US)

(21) Appl. No.: 15/424,520

(22) Filed: Feb. 3, 2017

Related U.S. Application Data
(60) Provisional application No. 62/291,660, filed on Feb. 5, 2016.

(51) Int. Cl. F16H 61/664

(52) U.S. Cl. CPC F16H 61/6647; F16H 15/503

(57) ABSTRACT

Provided herein is a control system for a multiple-mode continuously variable transmission having a ball planetary variator. The control system has a transmission control module configured to receive a plurality of electronic input signals, and to determine a mode of operation from a plurality of control ranges based at least in part on the plurality of electronic input signals. The system also has an adaptive ratio control module configured to store at least one calibration map, and configured to determine an adaptive speed ratio command signal during operation of the CVP.

### RELATED APPLICATION

This application claims the benefit of U.S. Provisional Application No. 62/291,660 filed on Feb. 5, 2016, which is herein incorporated by reference.

### BACKGROUND

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that are available to be implemented in a CVT are not be sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

The different transmission configurations could for example, multiply input torque across the different transmission stages in different manners to achieve the same final drive ratio. However, some configurations provide more flexibility or better efficiency than other configurations providing the same final drive ratio.

The criteria for optimizing transmission control could be different for different applications of the same transmission. For example, the criteria for optimizing control of a transmission for fuel efficiency will differ based on the type of prime mover applying input torque to the transmission. Furthermore, for a given transmission and prime mover pair, the criteria for optimizing control of the transmission will differ depending on whether fuel efficiency or performance is being optimized.

### SUMMARY

Provided herein is a computer-implemented system for a vehicle having an engine coupled to a continuously variable transmission having a ball-planetary variator (CVP), the computer-implemented system including: a digital processing device including an operating system configured to perform executable instructions and a memory device; a computer program including instructions executable by the digital processing device to create an application including a software module configured to manage a plurality of vehicle driving conditions; a plurality of sensors configured to monitor vehicle parameters including: CVP Speed Ratio, CVP Input Torque, CVP position, wherein the software module is configured to execute a feed-forward sub-module, wherein the feed-forward sub-module includes a base ratio-to-position calibration map configured to store values of a CVP position based at least in part on the CVP input torque and the CVP speed ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram schematic of a transmission control system that could be implemented in a vehicle.

FIG. 5 is a block diagram schematic of a speed ratio control sub-module that is implemented in the transmission control system of FIG. 4.

FIG. 6 is a block diagram schematic of an adaptive ratio control sub-module that is implemented in the speed ratio control sub-module of FIG. 5.

FIG. 7 is a block diagram schematic of an adaptive enable sub-module that is implemented in the adaptive ratio control sub-module of FIG. 7.

FIG. 8 is a block diagram schematic of a long-term adaptive control write sub-module that is implemented in the adaptive ratio control sub-module of FIG. 7.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. The electronic controller could be configured to receive input signals indicative of parameters associated with an engine coupled to the transmission. The parameters could include throttle position sensor values, accelerator pedal position sensor values, vehicle speed, gear selector position, user-selectable mode configurations, and the like, or some combination thereof. The electronic controller could also receive one or more control inputs. The electronic controller could determine an active range and an active variator mode based on the input signals and control inputs. The electronic controller could control a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent Application No. 14/425,842, entitled “3-Mode Front Wheel Drive And Rear Wheel Drive Continuously Variable Planetary Transmission” and, U.S. Patent Application Ser. No. 62/158,847, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, could be configured to control any of several types of variable ratio transmissions.

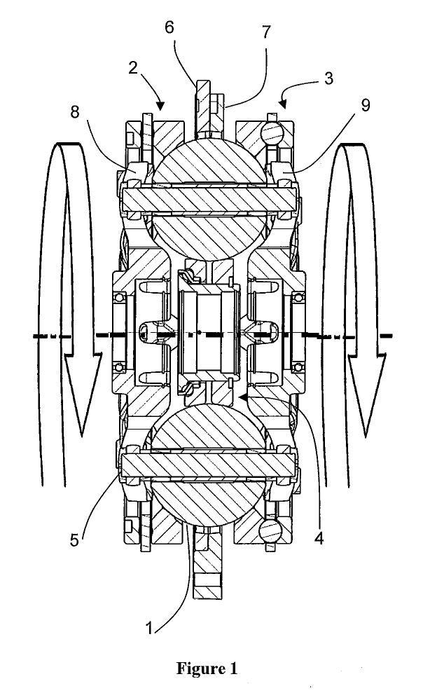

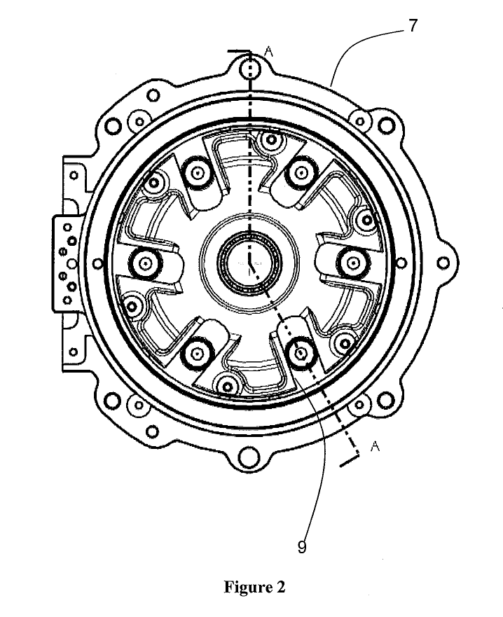

Provided herein are configurations of CVTs based on a ball type variator, also known as CVP, for continuously variable planetary. Basic concepts of a ball type Continuously Variable Transmissions are described in U.S. Pat. No. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as input traction ring 2 and output traction ring 3, and an idler (sun) assembly 4 as shown on FIG. 1. The balls are mounted on liftable axles 5, themselves held in a carrier (stator, cage) assembly having a first carrier member 6 operably coupled to a second carrier member 7. The first carrier member 6 rotates with respect to the second carrier member 7, and vice versa. In some embodiments, the first carrier member 6 is substantially fixed from rotation while the second carrier member 7 is configured to rotate with respect to the first carrier member, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

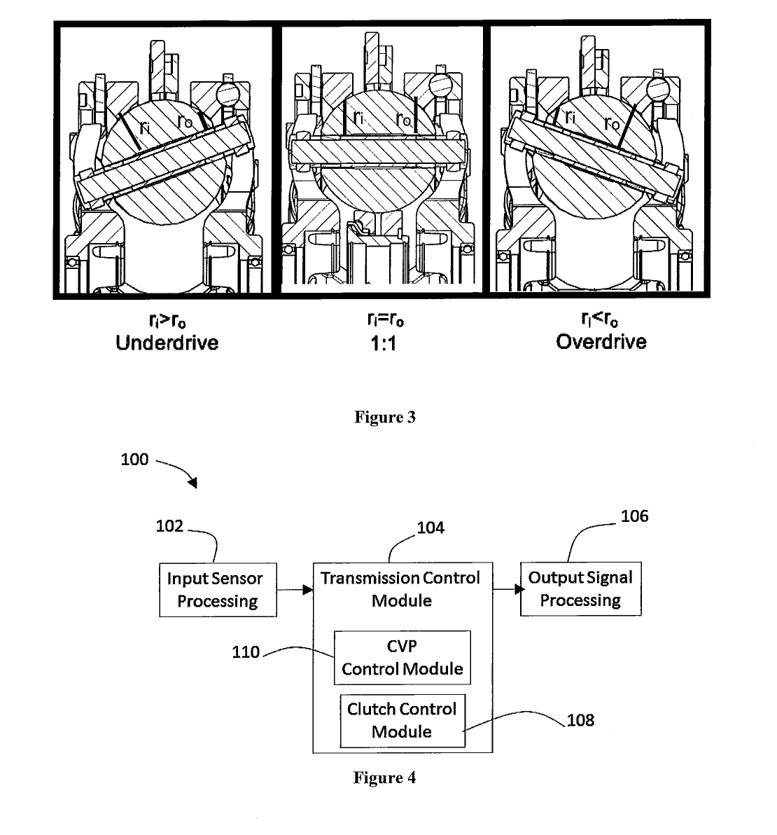

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments of the disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In one embodiment, a control system coordinates the use of a skew angle to generate forces between certain contacting components in the variator that will tilt the planet axis of rotation. The tilting of the planet axis of rotation adjusts the speed ratio of the variator.

For description purposes, the term “torque threshold”, as used herein, indicates a calibrateable value of torque at which a designer desires a control sub-module to enable operation or dis-able operation.

As used here, the terms “operationally connected,” “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis of a transmission or variator. The term “axial” as used herein refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades.

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source could be fueled by energy sources including hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission including this technology.

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments. For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the IVT includes a processor (not shown).

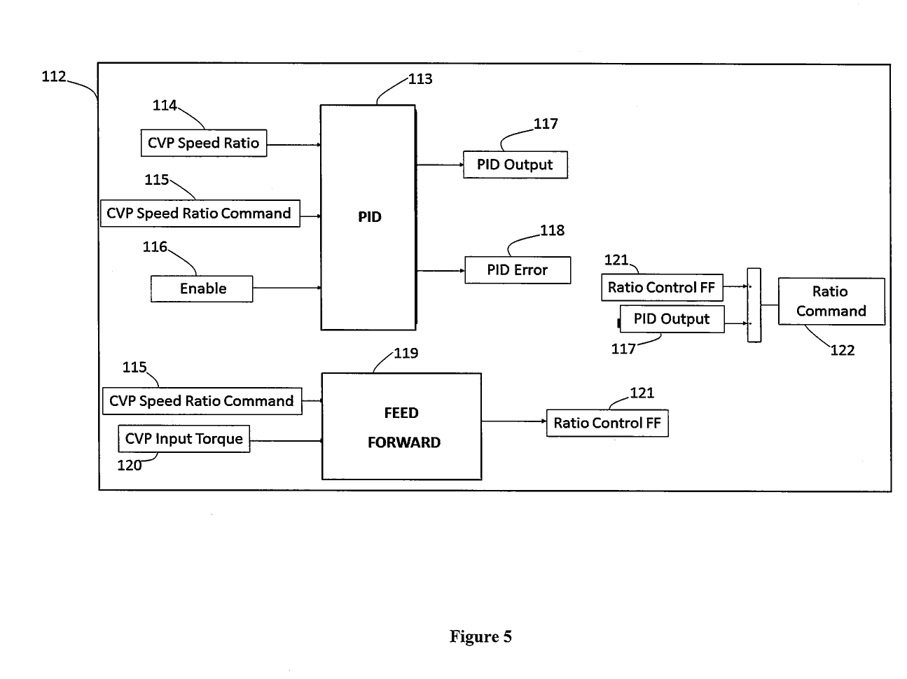

Referring now to FIG. 4, in one embodiment, a transmission controller 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others. In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors. In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here. For example, the transmission control module 104 optionally includes a clutch control sub-module 108 that is programmed to execute control over clutches or similar devices within the transmission. In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP. One sub-module included in the CVP control sub-module 110 is described herein.

Referring now to FIG. 5, in one embodiment, the CVP control sub-module 110 includes a speed ratio control sub-module 112. The speed ratio control sub-module 112 includes a PID sub-module 113 adapted to receive a CVP speed ratio signal 114, a commanded CVP ratio signal 115, and an enable signal 116. In one embodiment, the CVP speed ratio signal 114 is acquired from sensors equipped on the CVP and the CVP speed ratio signal 114 is indicative of a speed ratio at which the CVP is currently operating. In one embodiment, the commanded CVP ratio signal 115 is determined in another sub-module of the CVP control sub-module 110 and the commanded CVP ratio signal 115 is indicative of a desired ratio for the CVP. The enable signal 116 is determined by another sub-module of the CVP control sub-module 110 and provides a true or false indicator for the PID sub-module 113 to run. Typically, a PID controller, otherwise known as a proportional-integral-derivative controller, is configured for receiving a difference between a set point and a controlled variable of a process to be controlled and delivering a manipulated variable to the process, the process being operated by the manipulated variable to produce the controlled variable. The PID sub-module 113 determines an output signal 117 and an error signal 118. The output signal 117 is indicative of a control signal for the associated CVP actuators. The error signal 118 is associated with the difference between the commanded CVP ratio signal 115 and the CVP speed ratio signal 114.

In one embodiment, the speed ratio control sub-module 112 includes a feed-forward sub-module 119 adapted to receive the commanded CVP ratio signal 115 and a CVP input torque signal 120. The CVP input torque signal 120 is received from other sub-modules in the transmission control module 104 and is indicative of an input torque magnitude applied to the CVP. The feed-forward sub-module 119 determines a ratio control feed-forward signal 121 that is summed with the output signal 117 to form a ratio command signal 122. The ratio command signal 122 is used by other sub-modules of the transmission control module 104 to adjust the CVP during operation.

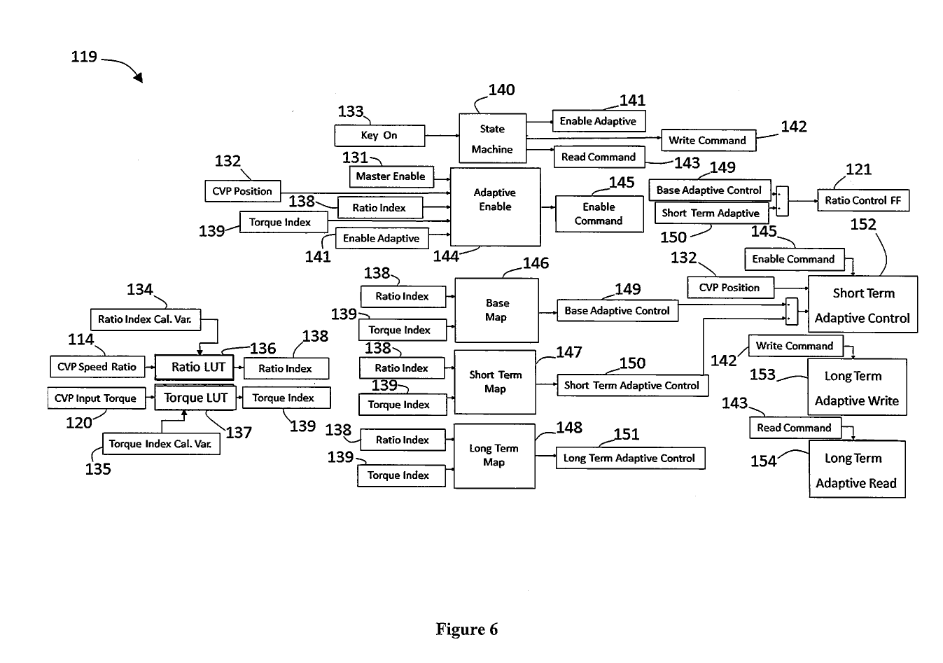

Referring now to FIG. 6, in one embodiment, the feed-forward sub-module 119 is configured to provide adaptive speed ratio control during operation of the CVP in order to enhance the performance of the transmission control module 104. As used here, the terms “adaptive” or “adaptive control” refers to a method of estimating control and/or calibration parameters during operation based on measured signals. In one embodiment, the feed-forward sub-module 119 is implemented in the CVP control sub-module 110. The feed-forward sub-module 119 receives the CVP speed ratio signal 114, the CVP input torque signal 120, a master enable signal 131, a CVP position signal 132, and a key-on signal 133. In one embodiment, the key-on signal 133 is associated with an indication from the vehicle operator that the vehicle is operational. The master enable signal 131 is determined in the transmission control module 104 and generally indicates that the engine is running, the CVP shift actuator is not faulted, any brakes applied to the shift actuator are not on, and any actuator enable calibrations are true. The CVP position signal 132 is indicative of a shift position of the CVP. In some embodiments, the shift position of the CVP corresponds to a position of the first carrier member 6 with respect to the second carrier member 7, for example. It should be noted that the embodiments disclosed herein are directed to a control method using shift position of the CVP as a control parameter. In other embodiments, a shift force of the CVP is optionally used in place of the position of the CVP in the control methods disclosed herein. For example, a shift force of the CVP is provided by the shift actuator. In some embodiments, the shift actuator is a hydraulic device. In other embodiments, the shift actuator is an electronic device having a motor. In yet other embodiments, the shift actuator is an electro-hydraulic device. The key-on signal 133 is indicative of a signal associated with a user turning the vehicle on for operation. The feed-forward sub-module 119 receives a ratio index calibration variable 134 and a torque index calibration variable 135, which will be described later. The feed-forward sub-module 119 includes a ratio look-up table 136 configured to receive the CVP speed ratio signal 114. The feed-forward sub-module 119 includes a torque look-up table 137 configured to receive the CVP input torque signal 120. The ratio look-up table 136 passes a ratio index signal 138 based at least in part on the ratio index calibration variable 134 and the CVP speed ratio signal 114. The ratio index signal 138 is indicative of a row position and an interpolation fraction for a calibration map as will be described herein. The torque look-up table 137 passes a torque index signal 139 based at least in part on the torque index calibration variable 135 and the CVP input torque signal 120. The torque index signal 139 is indicative of a column position and an interpolation fraction for a calibration map as will be described herein.

Still referring to FIG. 6, in one embodiment, the feed-forward sub-module 119 includes a state machine 140 configured to receive the key-on signal 133. The state machine 140 evaluates vehicle and CVP conditions and determines an enable adaptive control signal 141, a write command signal 142, and a read command signal 143. The feed-forward sub-module 119 includes an adaptive enable sub-module 144 configured to receive the master enable signal 131, the CVP position signal 132, the ratio index signal 138, the torque index signal 139, and the enable adaptive control signal 141. The adaptive enable sub-module 144 evaluates the input signals and determines an enable command signal 145. The adaptive enable sub-module 144 is optionally configured to evaluate operating conditions and compare to pre-determined thresholds in order to determine if the enable command signal 145 is true or false. As will be discussed herein, the enable command signal 145 governs the real-time updating of the ratio-to-position calibration map 125.

Still referring to FIG. 6, in one embodiment, the feed-forward sub-module 119 includes a base ratio-to-position calibration map 146, a short-term ratio-to-position calibration map 147, and a long-term ratio-to-position calibration map 148. The base ratio-to-position calibration map 146 passes a base non-adaptive control signal 149 based at least in part on the ratio index signal 138 and the torque index signal 139. The short-term ratio-to-position calibration map 147 passes a short-term adaptive control signal 150 based at least in part on the ratio index signal 138 and the torque index signal 139. The long-term ratio-to-position calibration map 148 passes a long-term adaptive control signal 151 based at least in part on the ratio index signal 138 and the torque index signal 139.

In one embodiment, the feed-forward sub-module 119 includes a short-term adaptive control sub-module 152 configured to receive the enable command signal 145. During operation, when the enable command signal 145 is true, the short-term adaptive control sub-module 152 executes instructions to populate the values of the short-term ratio-to-position calibration map 147 based at least in part on the CVP position signal 132 and the summed value of the base adaptive control signal 149 and the short-term ratio-to-position control signal 150. The summed value of the base adaptive control signal 149 and the short-term ratio-to-position control signal 150 is the ratio control feed forward signal 121. The ratio control feed forward signal 121 is passed out of the feed-forward sub-module 119 for use in the speed ratio control sub-module 112. The feed-forward sub-module 119 includes a long-term adaptive control write sub-module 153 and a long-term adaptive control read sub-module 154. The long-term adaptive control write sub-module 153 receives the write command signal 142 from the state machine 140. The long-term adaptive control write sub-module 153 is configured to compute a moving average of the long-term control signal values 151 generated during operation. The long-term adapted control write sub-module 153 is also configured to compute the moving average of the current short-term control signal values 150. The long-term control write sub-module 153 is configured to write the computed moving averages to memory based at least in part on the write command signal 142. The long-term adaptive control read sub-module 154 receives the read command signal 143 from the state machine 140. The long-term adaptive control read sub-module 154 is configured to read stored values of the long-term ratio-to-position calibration map 148 from memory and populate the short-term ratio-to-position calibration map 147 with said values based at least in part on the read command signal 143.

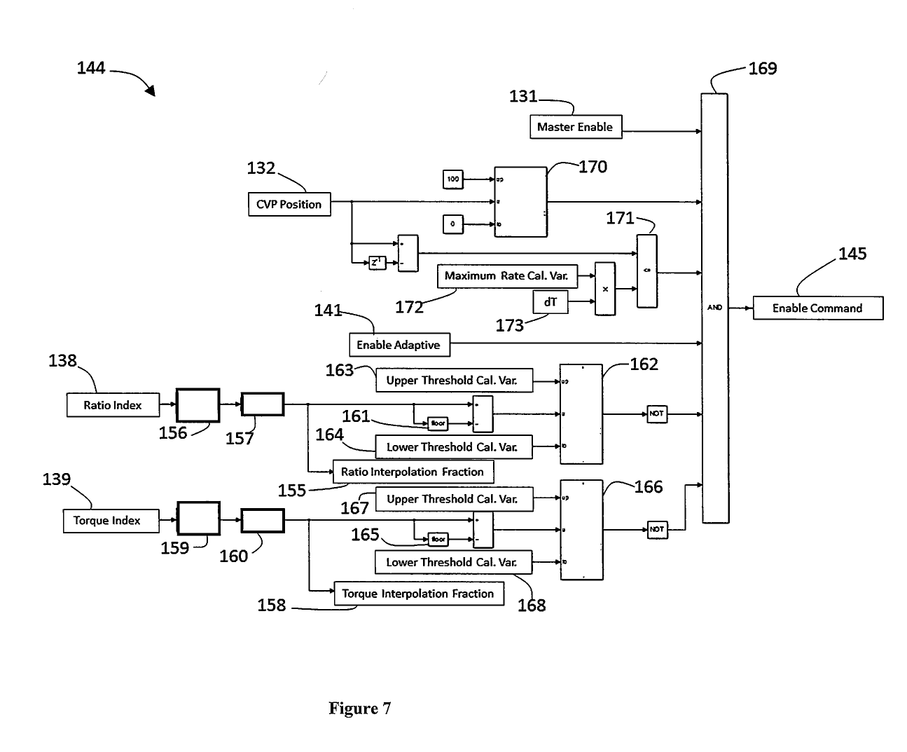

Passing now to FIG. 7, in one embodiment, the adaptive enable sub-module 144 is configured to determine a ratio interpolation fraction signal 155 based at least in part on the ratio index signal 138 and a first data conversion block 156 and a second data conversion block” 157. The adaptive enable sub-module 144 is configured to determine a torque interpolation fraction signal 158 based at least in part on the torque index signal 139 and a third data conversion block 159 and a fourth data conversion block 160. As used here, the first data conversion block 156 and the third data conversion block 159 refer to well-known software implemented processes that convert the index signals to double precision floating point numbers. The second data conversion block 157 and the fourth conversion block 160 refers to well-known software implemented processes that convert double precision point floating numbers to single precision floating-point numbers. It should be appreciated that a designer optionally configures data conversion blocks to suit selected software and hardware implementations of the adaptive enable sub-module 144. In one embodiment, the ratio interpolation fraction signal 155 is passed to a first floor function block 161 that passes integer portion of the ratio interpolation fraction signal 155 to a first evaluation block 162. As used here, the first floor function block 161 refers to a well-known software implemented mathematical function configured to associate a real number to the largest previous or the smallest following integer. Stated differently, the first floor function block 161 passes the next nearest integer or whole number value of the ratio interpolation fraction signal 155. The first evaluation block 162 receives a first calibration variable 163 indicative of an upper threshold for the ratio interpolation fraction signal 155. The first evaluation block 162 receives a second calibration variable 164 indicative of a lower threshold for the ratio interpolation fraction signal 155. The first evaluation block 162 passes a true signal if the result determined in the first floor function block 161 is between the first calibration variable 163 and the second calibration variable 164. In one embodiment, the torque interpolation fraction signal 158 is passed to a second floor function block 165 that passes the decimal portion of the torque interpolation fraction signal 158 to a second evaluation block 166. The second evaluation block 166 receives a third calibration variable 167 indicative of an upper threshold for the torque interpolation fraction signal 158. The second evaluation block 166 receives a fourth calibration variable 168 indicative of a lower threshold for the torque interpolation fraction signal 158. The second evaluation block 166 passes a true signal if the result determined in the second floor function block 165 is between the third calibration variable 167 and the fourth calibration variable 168. A

Boolean block 169 receives inverse of the resulting signals from the first evaluation block 162 and the second evaluation block 166. The Boolean block 169 receives the master enable signal 131 and the enable adaptive control signal 141. In one embodiment, the adaptive enable sub-module 144 receives the CVP position signal 132 that is passed to a third evaluation block 170. The third evaluation block 170 compares the CVP position signal 132 to upper and lower threshold values that are optionally configured to be calibration variables. The third evaluation block 170 passes a true signal when the CVP position signal 132 is between the upper and lower threshold values. A difference between the CVP position signal 132 and the CVP position signal 132 of the previous computational step is passed to a comparison block 171. The comparison block 171 compares the difference to a product of a maximum rate calibration variable 172 and a time step calibration variable 173. In other words, the comparison block 171 compares the change in the CVP position signal 132 between computational time steps to a maximum rate of change and passes a true signal if the change is less than the maximum. The comparison block 171 passes the result to the Boolean block 169. The Boolean block 169 determines the enable command signal 145 based on the input signals described.

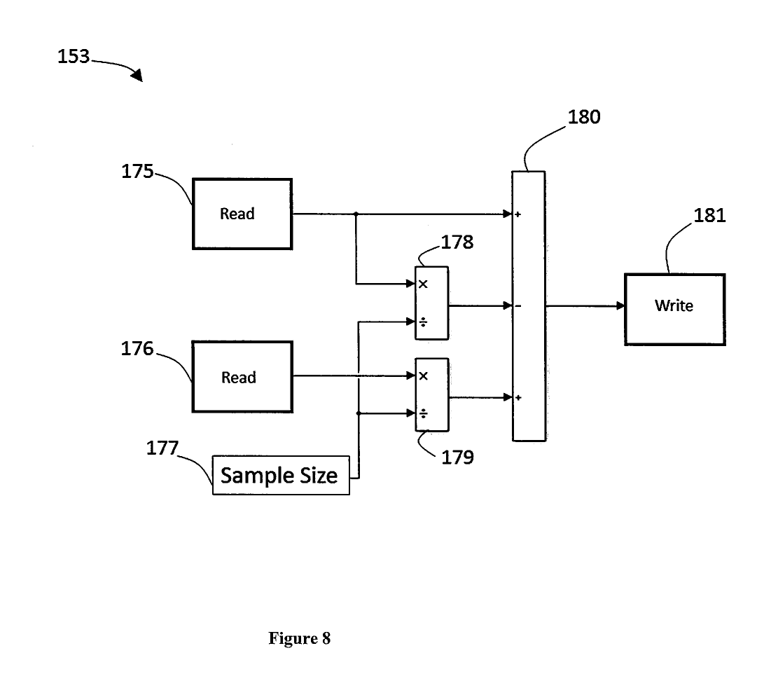

Turning now to FIG. 8 and still referring to FIG. 6, in one embodiment, the long-term adaptive control write sub-module 153 is optionally configured to provide an approximate running average of data generated during operation of the CVP. For example, a first function block 175 is configured to read the values of the long-term ratio-to-position calibration map 148. A second function block 176 is configured to read the values of the short-term ratio-to-position calibration map 147. A sample size calibration variable 177 is read from memory and indicates the number of data samples averaged in the first function block 175. A first division block 178 divides each element of the first function block 175 by the sample size calibration variable 177. The second division block 179 divides the each element of the second function block 176 by the sample size calibration variable 177. A summation block 180 is configured to subtract the result of the first division block 178 from the result of the first function block 175 and sum the result of the second division block 179. The result of the summation block 180 passes a resulting signal to a third function block 181 where the data is written to memory. As an illustrative example, the function block 175 reads the current values from the long-term ratio-to-position calibration map 148. The long-term ratio-to-position calibration map 148 contains 32×9 (for example) values equal to the average of the last X number of samples (stored at key-off) where X is the sample size calibration variable 177. The summation block 180 takes the current average values in the long-term ratio-to-position calibration map 148, subtracts the first sample in the 10 sample series (as an approximation), and adds a new value (short-term ratio-to-position calibration map 147), to generate a new average. The new average value is then passed to the long-term ratio-to-position calibration map 148.

It should be noted that the description above has provided dimensions for certain components or subassemblies. The mentioned dimensions, or ranges of dimensions, are provided in order to comply as best as possible with certain legal requirements, such as best mode. However, the scope of the embodiments described herein are to be determined solely by the language of the claims, and consequently, none of the mentioned dimensions is to be considered limiting on the inventive embodiments, except in so far as any one claim makes a specified dimension, or range of thereof, a feature of the claim.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the embodiments with which that terminology is associated.

While preferred embodiments of the present embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein could be employed in practice. It is intended that the following claims define the scope of the preferred embodiments and that methods and structures within the scope of these claims and their equivalents be covered thereby.

What is claimed is:

1. A computer-implemented system for a vehicle having an engine coupled to a continuously variable transmission having a ball-planetary variator (CVP), the computer-implemented system comprising:
a digital processing device comprising an operating system configured to perform executable instructions and a memory device;
a computer program including instructions executable by the digital processing device to create an application comprising a software module configured to manage a plurality of vehicle driving conditions; and
a plurality of sensors configured to monitor vehicle parameters comprising:
CVP speed ratio,
CVP input torque,
CVP position,
wherein the software module is configured to execute a feed-forward sub-module, and
wherein the feed-forward sub-module includes a base ratio-to-position calibration map configured to store values of the CVP position based at least in part on the CVP input torque and the CVP speed ratio.

2. The computer-implemented system of claim 1, wherein the feed-forward sub-module further comprises:
a state machine configured to evaluate vehicle sensors; and
a CVP sensor to determine an enable adaptive control signal.

3. The computer-implemented system of claim 2, wherein the feed-forward sub-module further comprises an adaptive enable sub-module.

4. The computer-implemented system of claim 3, wherein the feed-forward sub-module further comprises a short-term ratio-to-position calibration map.

5. The computer-implemented system of claim 4, wherein the feed-forward sub-module further comprises a long-term ratio-to-position calibration map.

6. The computer-implemented system of claim 5, wherein the state machine is configured to determine a write command signal.

7. The computer-implemented system of claim 6, wherein the state machine is configured to determine a read command signal.

8. The computer-implemented system of claim 7, wherein the feed-forward sub-module is configured to determine a ratio index signal based at least in part on the CVP speed ratio.

9. The computer-implemented system of claim 8, wherein the feed-forward sub-module is configured to determine a torque index signal based at least in part on the CVP input torque.

10. The computer-implemented system of claim 9, wherein the base ratio-to-position calibration map is configured to provide a CVP position signal based at least in part on the ratio index signal and the torque index signal.

11. The computer-implemented system of claim 10, wherein the short-term ratio-to-position calibration map is configured to provide a CVP position signal based at least in part on the ratio index signal and the torque index signal.

12. The computer-implemented system of claim 11, wherein the long-term ratio-to-position calibration map is configured to provide the CVP position signal based at least in part on the ratio index signal and the torque index signal.

13. The computer-implemented system of claim 12, wherein the adaptive enable sub-module is configured to receive the ratio index signal and the torque index signal.

14. The computer-implemented system of claim 13, wherein the feed-forward sub-module further comprises a short-term adaptive control sub-module.

15. The computer-implemented system of claim 14, wherein the feed-forward sub-module further comprises a long-term adaptive control write sub-module.

16. The computer-implemented system of claim 15, wherein the feed-forward sub-module further comprises a long-term adaptive control read sub-module.

17. The computer-implemented system of claim 16, wherein the long-term adaptive control write sub-module is configured to write a computed moving average to memory based at least in part on the write command signal.

18. The computer-implemented system of claim 17, wherein the long-term adaptive control read sub-module is configured to read the long-term ratio-to-position calibration map from memory based at least in part on the read command signal.

19. The computer-implemented system of claim 18, further comprising a PID sub-module configured to determine a control signal for a CVP actuator.

20. The computer-implemented system of claim 19, wherein the feed-forward sub-module is configured to determine a ratio control feed-forward signal, wherein the ratio control feed-forward signal is summed with the control signal determined by the PID sub-module to form a ratio command signal.
